(19) United States
(12) Patent Application Publication
(10) Pub. No.: US 2015/0045930 A1
(43) Pub. Date: Feb. 12, 2015

(54) TEST DEVICE AND METHOD FOR TESTING WHETHER A WORKPIECE IS POSITIONED CORRECTLY

(71) Applicant: Wistron Corporation, New Taipei City (TW)

(72) Inventors: Chieh-Jo Wang, New Taipei City (TW); Chia-Hsiung Hsueh, New Taipei City (TW); Yuan-Shun Chang, New Taipei City (TW); Chun-Wang Lin, New Taipei City (TW)

(73) Assignee: Wistron Corporation, New Taipei City (TW)

(21) Appl. No.: 14/145,992

(22) Filed: Jan. 1, 2014

(30) Foreign Application Priority Data
Aug. 7, 2013 (TW) 102128361

(51) Int. Cl. G05B 19/402

(52) U.S. Cl. CPC G05B 19/402; G05B 2219/49001
USPC 700/114

(57) ABSTRACT

A test device includes a base, a locating component installed on the base, a platform disposed on the base, an operating component, a driving component installed on the platform, at least one light emitting component, at least one sensing component and a control unit. The driving component is for driving the operating component. The at least one light emitting component is disposed on at least one track of the platform for emitting light. The at least one sensing component is for sensing the light emitted from the at least one light emitting component and reflected from the workpiece. The control unit determines whether to control the driving component to drive the operating component to move to the workpiece according a sensing result of the at least one sensing component sensing the light emitted from the at least one light emitting component and reflected from the workpiece.

### BACKGROUND OF THE INVENTION

1. Field of the Invention

The present invention relates to a test device and a test method, and more specifically, to a test device and a test method for testing whether a workpiece is positioned correctly.

2. Description of the Prior Art

In a test or assembly procedure of a product, such as a notebook computer, in a production line, the product is often located on a fixture is by a mechanism or an operator manually. Therefore, the product cannot be correctly positioned on the fixture easily due to negligence of the operator, resulting in damage of a workpiece in the procedure of assembly. As a result, it needs to reassemble and replace new material, causing a problem of wasting human power and increasing cost. Therefore, it is an important issue to design a test device for locating the workpiece on the fixture correctly.

### SUMMARY OF THE INVENTION

The present invention is to provide a test device and a method for locating a workpiece on a fixture correctly to solve above problems.

According to the disclosure, a test device includes a base, a locating component, a platform, at least one linking component, an operating component, a driving component, at least one light emitting component, at least one sensing component and a control unit. The locating component is installed on the base, and a locating structure is formed on the locating component and for accommodating and locating the workpiece. The platform is disposed on the base and facing the base. The at least one linking component links the base and the platform, so as to form a space between the base and the platform. The operating component is disposed on a side of the platform facing the locating component. The driving component is installed on the platform and for driving the operating component to move to the locating component or move away from the locating component selectively. The least one light emitting component is disposed on the platform, and the at least one light emitting component is for emitting light to the workpiece located on the locating component. The at least one sensing component is for sensing the light emitted from the at least one light emitting component and reflected from the workpiece. The control unit is electrically connected to the driving component, the at least one light emitting component, the at least one sensing component and the driving component. The control unit is for determining whether to control the driving component to drive the operating component to move to the workpiece according to a comparison standard and a sensing result of the at least one sensing component sensing the light emitted from the at least one light emitting component and reflected from the workpiece.

According to the disclosure, the test device comprises a predetermined number of the light emitting components and a predetermined number of the sensing components, the control unit is further for controlling the predetermined number of the light emitting components to emit the light to the workpiece, and the control unit determines whether to control the driving component to drive the operating component to move to the workpiece according to the comparison standard and the sensing result of the predetermined number of the sensing components sensing the light emitted from the predetermined number of the light emitting components and reflected from the workpiece.

According to the disclosure, the test device further includes a storage unit for storing at least one predetermined distance characteristic value, and the control unit is further for calculating a predetermined number of distance characteristic values after the predetermined number of the sensing components sense the light emitted from the predetermined number of the light emitting components and reflected from the workpiece. The control unit determines whether to control the driving component to drive the operating component to move to the workpiece according to the comparison standard of comparing the predetermined number of distance characteristic values with the at least one predetermined distance characteristic value.

According to the disclosure, the control unit is for controlling the driving component to drive the operating component to move to the workpiece as the control unit determines that every difference between the predetermined number of distance characteristic values and the at least one predetermined distance characteristic value is less than a predetermined tolerance.

According to the disclosure, the control unit is further for calculating a predetermined number of distance characteristic values after the predetermined number of the sensing components sense the light emitted from the predetermined number of the light emitting components and reflected from the workpiece, and the control unit determines whether to control the driving component to drive the operating component to move to the workpiece according to the predetermined number of distance characteristic values.

According to the disclosure, the control unit is for controlling the driving component to drive the operating component to move to the workpiece as the control unit determines that every difference between the predetermined number of distance characteristic values and an average value of the predetermined number of distance characteristic values is less than a predetermined tolerance.

According to the disclosure, the control unit is for controlling the driving component to drive the operating component to move to the workpiece as the control unit determines that a difference between a maximum distance characteristic value and a minimum distance characteristic value of the predetermined number of distance characteristic values is less than a predetermined tolerance.

According to the disclosure, the control unit is further for controlling the at least one light emitting component to emit the light to a corner or a side of the workpiece and determining whether to control the driving component to drive the operating component to move to the workpiece according to the comparison standard and the sensing result of the at least one sensing component sensing the light emitted from the at least one light emitting component and reflected from the corner or the side of workpiece.

According to the disclosure, a method for testing whether a workpiece is positioned correctly includes at least one light emitting component emitting light to a workpiece located on a locating component; at least one sensing component sensing the light emitted from the at least one light emitting component and reflected from the workpiece; and a control unit determining whether to control the driving component to drive the operating component to move to the workpiece according to a comparison standard and a sensing result of the at least one sensing component sensing the light emitted from the at least one light emitting component and reflected from the workpiece.

The test device includes the control unit to control the plurality of light emitting components to emit the light to the workpiece, and the sensing result of the plurality of sensing components sensing the light emitted from the plurality of light emitting component and reflected from the workpiece is sent to the control unit. Finally, the control unit determines whether to control the driving component to drive the operating component to press the attachment onto the workpiece according to the comparison standard and the sensing result. That is, the test device can test whether the workpiece is disposed in the locating structure horizontally, so as to prevent the operating component from damaging the workpiece in the assembly procedure. Therefore, it solves the conventional problems that the workpiece is not correctly positioned on the fixture, resulting in damaging the workpiece in the procedure of assembly, wasting human power and increasing cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a test device according to an embodiment of the present invention.

FIG. 2 is a diagram of the test device according to the embodiment of the present invention.

FIG. 3 is a diagram of the test device in another view according to the embodiment of the present invention.

FIG. 4 is a diagram of a light emitting component and a set of sensing components according to the embodiment of the present invention.

FIG. 5 is a flow chart of testing whether a workpiece is positioned correctly by the test device according to the embodiment of the present invention.

### DETAILED DESCRIPTION

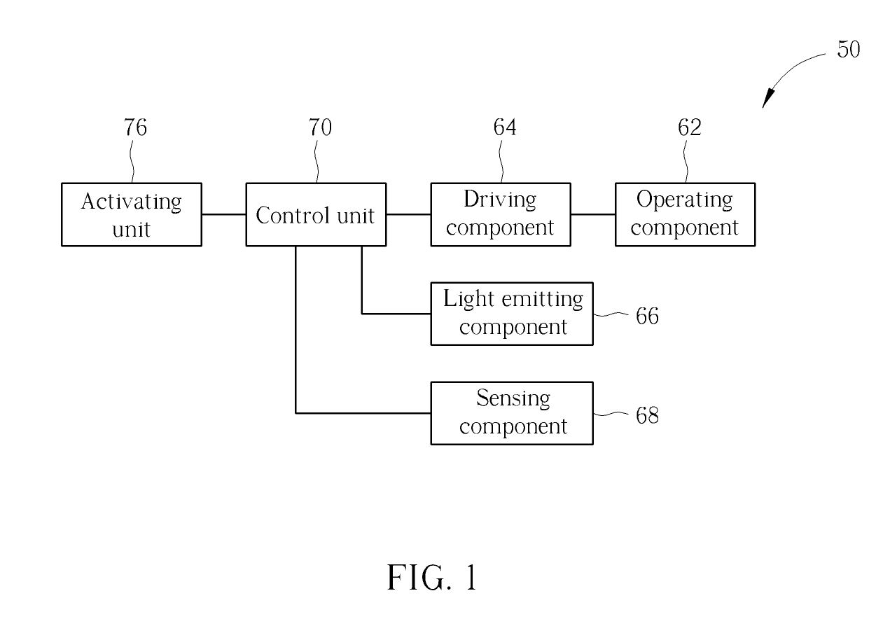

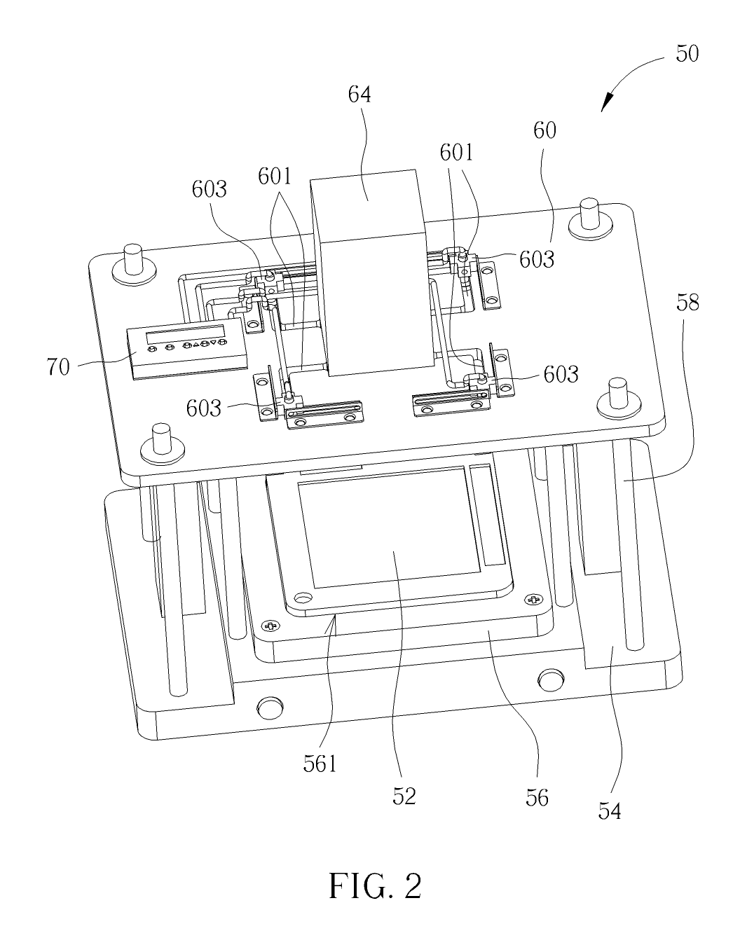

Please refer to FIG. 1 to FIG. 2. FIG. 1 is a functional block diagram of a test device 50 according to an embodiment of the present invention. FIG. 2 is a diagram of the test device 50 according to the embodiment of the present invention. The test device 50 is for testing whether a workpiece 52 is disposed correctly. The test device 50 includes a base 54, a locating component 56, at least one connecting component 58, a platform 60, an operating component 62, a driving component 64, at least one light emitting component 66, at least one sensing component 68 and a control unit 70. The locating component 56 is installed on the base 54, and a locating structure 561 is formed on the locating component 56, such as a locating slot. The locating structure 561 is for accommodating and locating the workpiece 52, as shown in FIG. 2. The locating component 56 can be a fixture and can be replaced according to different sizes of different workpieces 52. The platform 60 is disposed on the base 54 and faces the base 54. In this embodiment, the test device 50 can include eight connecting components 58, and each connecting component 58 can be a rod. An end of each connecting component 58 is connected to the base 54, and the other end of each connecting component 58 is connected to the platform 60. That is, the eight connecting components 58 are between the base 54 and the platform 60, so as to form a space between the base 54 and the platform 60. The locating component 56 is disposed between the base 54 and the platform 60. In addition, at least one guiding structure, such as a guiding slot 601, is formed on the platform 60. In this embodiment, there are four guiding slots 601 formed on the platform 60.

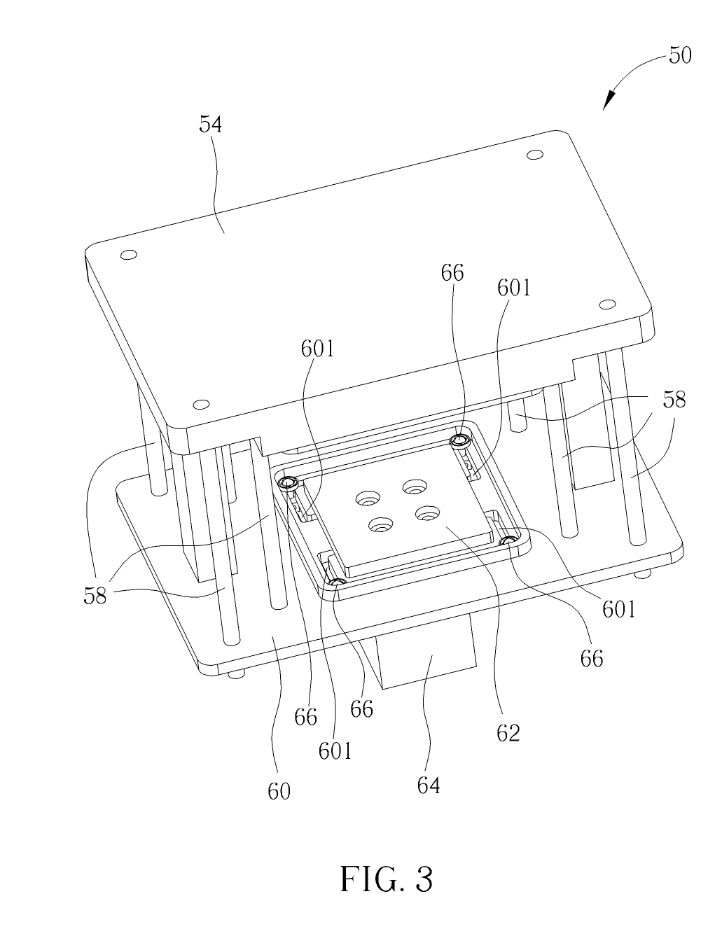

Please refer to FIG. 2 and FIG. 3. FIG. 3 is a diagram of the test device 50 in another view according to the embodiment of the present invention. As shown in FIG. 3, the operating component 62 is disposed on a side of the platform 60 facing the locating component 56. As shown in FIG. 3, the driving component 64 is installed on the platform 60, and the driving component 64 can be a cylinder. The driving component 64 is for driving the operating component 62 to move to the locating component 56 or move away from the locating component 56 selectively. The at least one light emitting component 66 is disposed on the corresponding guiding slot 601 of the platform 60 and for moving along the guiding structure, so as to adjust a position of the at least one light emitting component. The at least one light emitting component 66 is for emitting light to the workpiece 52 located on the locating component 56. In this embodiment, the test device 50 includes four light emitting components 66 disposed on the four guiding slots 601 respectively.

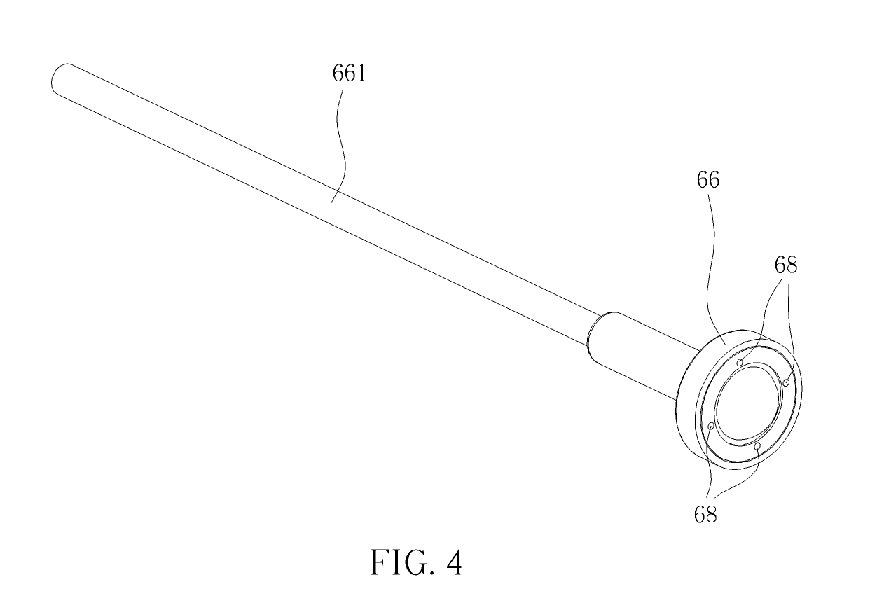

Please refer to FIG. 4. FIG. 4 is a diagram of the light emitting component 66 and the sensing components 68 according to the embodiment of the present invention. Each sensing component 68 is for sensing the light emitted from the corresponding light emitting component 66 and reflected from the workpiece 52. As shown in FIG. 4, in this embodiment, a set of sensing component 68 is disposed on each light emitting component 66. Furthermore, each light emitting component 66 is connected to the control unit 70 by a wire 661, and the light emitting component 66 can be a far infrared lamp or a laser emitter. The control unit 70 is electrically connected to the driving component 64, every light emitting component 66 and every sensing component 68. The control unit 70 is for determining whether to control the driving component 64 to drive the operating component 62 to move to the workpiece 52 according to a comparison standard and a sensing result of each sensing component 68 sensing the light emitted from the corresponding light emitting component 66 and reflected from the workpiece 52. That is, the control unit 70 controls the driving component 64 to drive the operating component 62 to press an attachment, not shown in figures, to the workpiece 52. For example, the workpiece 52 can be a touch display screen, and the attachment can be a membrane. A shape of the membrane can correspond to a shape of a frame of the touch display screen.

As the test device 50 only includes one light emitting component 66 and one set of sensing component 68, the guiding slot 601 can be formed as a ring-shape structure or a C-shaped structure and cover four corners or four sides of the workpiece 52, and the control unit 70 can control the light emitting component 66 to move along the guiding slot 601 to emit the light to the four corners or the four sides of the workpiece 52. Then, the sensing component 68 can receive the light reflected from the workpiece 52. Finally, the control unit 70 determines whether to control the driving component 64 to drive the operating component 62 to press the attachment onto the workpiece 52 according to the comparison standard.

As shown in figures, when the test device 50 includes four light emitting components 66 and four sensing components 68 disposed on the four guiding slots 601 respectively, the control unit 70 can control the four light emitting components 66 to emit the light to the four corners or the four sides of the workpiece 52 sequentially or simultaneously. In addition, as shown in FIG. 2, the test device 50 further includes four adjustable fixing components 603, and each light emitting component 66 is fixed on the corresponding adjustable fixing component 603. Each adjustable fixing component 603 is movably installed on the corresponding guiding slot 601. The adjustable fixing component 603 is released to move along the corresponding guiding slot 601 and can convey the corresponding light emitting component 66 to a fixed position to emit the light. Therefore, the light emitting component 66 can be adjusted to different positions relative to the corresponding guiding slot 601 for the workpiece 52 with different sizes or for testing different positions of the workpiece 52. Then, the control unit 70 determines whether to control the driving component 64 to drive the operating component 62 to press the attachment onto the workpiece 52 according to the comparison standard and a sensing result of the four sensing components 68 sensing the light emitted from the four light emitting components 66 and reflected from the four corners or the four sides of the workpiece 52. The control unit 70 can calculate four distance characteristic values D1-D4 according to the sensing result of the four sensing components 68 sensing the light emitted from the four light emitting components 66 and reflected from the four corners or the four sides of the workpiece 52, and the control unit 70 determines whether to control the driving component 64 to drive the operating component 62 to press the attachment onto the workpiece 52 according to the four distance characteristic values D1-D4. Each distance characteristic value can be derived from a product of the light velocity and a half of time from the light emitting component 66 emitting the light to the sensing component 68 sensing the reflected light.

For example, the control unit 70 can compare the four distance characteristic values D1-D4 with an average value DA of the four distance characteristic values D1-D4. As the control unit 70 determines that every difference between the four distance characteristic values D1-D4 and the average value DA of the four distance characteristic values D1-D4 is less than a predetermined tolerance E1, it indicates that differences of distances between the four corners of the workpiece 52 and the four sensing components 68 are small, so that the workpiece 52 can be regarded to be disposed inside the locating structure 561 of the locating component 56 horizontally. Therefore, a following assembly can be operated. For example, the control unit 70 can control the driving component 64 to drive the operating component 62 to press the attachment onto the workpiece 52. The comparison standard is that as the control unit determines that every difference between the four distance characteristic values D1-D4 and the average value DA of the four distance characteristic values D1-D4 is less than the predetermined tolerance E1, the control unit 70 controls the driving component 64 to drive the operating component 62 to press the attachment onto the workpiece 52. That is, as every difference DE1(D1-DA), DE2(D2-DA), DE3(D3-DA) and DE4(D4-DA) is less than the predetermined tolerance E1, the control unit 70 controls the driving component 64 to drive the operating component 62 to press the attachment onto the workpiece 52. If one or more than one of differences are greater than the predetermined tolerance E1, it means the workpiece 52 is not disposed in the locating structure 561 horizontally, and the control unit 70 does not control the driving component 64 to move, so as to prevent the operating component 62 from damaging the workpiece 52.

Furthermore, the test device 50 of another embodiment can include a storage unit 74 for storing four predetermined distance characteristic values PD1-PD4, and the control unit 70 is also for calculating the four distance characteristic values D1-D4 after the four sensing components 68 sense the light emitted from the four light emitting components 66 and reflected from the four corners or the four sides of the workpiece 52 respectively. Then, the control unit 70 determines whether to control the driving component 64 to drive the operating component 62 to press the attachment onto the workpiece 52 according to the comparison standard of comparing the four distance characteristic values D1-D4 with the four predetermined distance characteristic values PD1-PD4 respectively. For example, the comparison standard is that as the control unit determines that every difference between the four distance characteristic values D1-D4 and the four predetermined distance characteristic values PD1-PD4 is less than a predetermined tolerance E2, the control unit 70 controls the driving component 64 to drive the operating component 62 to press the attachment onto the workpiece 52. As differences DE5(D1-PD1), DE6(D2-PD2), DE7(D3-PD3) and DE8(D4-PD4) between the four distance characteristic values D1˜D4 and the four predetermined distance characteristic values PD1˜PD4 are less than the predetermined tolerance E2 respectively, it indicates that distances between the four corners of the workpiece 52 and the four sensing components 68 are all within a predetermined range, so that the workpiece 52 can be regarded to be disposed inside the locating structure 561 of the locating component 56 horizontally. Therefore, a following assembly can be operated. For example, the control unit 70 controls the driving component 64 to drive the operating component 62 to press the attachment onto the workpiece 52. That is, as every difference DE5, DE6, DE7 and DE8 is less than the predetermined tolerance E2, the control unit 70 controls the driving component 64 to drive the operating component 62 to press the attachment onto the workpiece 52. On the contrary, if one or more than one of differences are greater the predetermined tolerance E2, it means the workpiece 52 is not disposed in the locating structure 561 horizontally, and the control unit 70 does not control the driving component 64 to move, so as to prevent the operating component 62 from damaging the workpiece 52.

In another embodiment, the control unit 70 can also determines whether to control the driving component 64 to drive the operating component 62 to press the attachment onto the workpiece 52 according to comparison of a difference between a maximum distance characteristic value and a minimum distance characteristic value of the four distance characteristic values D1-D4 and a predetermined tolerance E3. At this time, the comparison standard is that as the control unit 70 determines that the difference between the maximum distance characteristic value and the minimum distance characteristic value of the four distance characteristic values D1-D4 is less than the predetermined tolerance E3, the control unit 70 controls the driving component 64 to drive the operating component 62 to move to the workpiece 52. That is, if D1 is the maximum distance characteristic value and D4 is the minimum distance characteristic value, the control unit 70 determines whether to control the driving component 64 according to that the control unit 70 determines whether the difference between D4 and D1 is less than the predetermined tolerance E3. Comparison standards for controlling the driving component 64 by the control unit 70 are not limited to above-mentioned comparison standards, and it depends on practical design demands.

Moreover, the test device 50 of the present invention can further include an activating unit 76 electrically connected to the control unit 70 and for sending an activating signal to the control unit 70, so that the control unit 70 controls the at least one light emitting component 66 to emit the light, so as to perform following procedures. That is, the activating unit 76 can be an activating switch of the test device 50 of the present invention. The activating unit 76 can be designed to include a plurality of activating buttons, and the activating signal can be sent to the control unit 70 only when the plurality of activating buttons is pressed at the same time, so as to prevent the test device 50 from being activated by a careless operation.

Numbers of the light emitting component 66 and the sensing component 68 are not limited to above embodiment. That is, the test device 50 of the present invention can include one guiding slot 601, one light emitting component 66 and one sensing component 68, and the test device 50 can also include a plurality of guiding slot 601, a plurality of light emitting component 66 and a plurality of sensing component 68. For the above examples, the operational principle of the control unit 70 is the same with previous embodiments and is omitted herein.

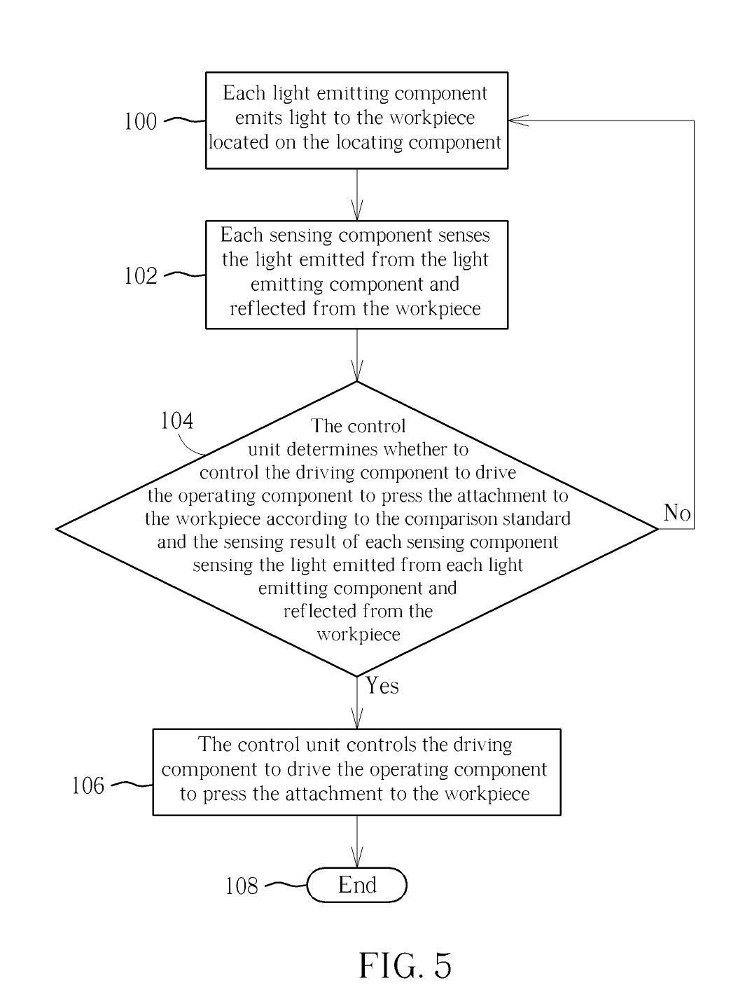

A method of the test device 50 of the present invention is described as follows. Please refer to FIG. 5. FIG. 5 is a flow chart of testing whether the workpiece 52 is positioned correctly by the test device 50 according to the embodiment of the present invention. The method includes following steps:

Step 100: Each light emitting component 66 emits light to the workpiece 52 located on the locating component 56.

Step 102: Each sensing component 68 senses the light emitted from the light emitting component 66 and reflected from the workpiece 52.

Step 104: The control unit 70 determines whether to control the driving component 64 to drive the operating component 62 to press the attachment to the workpiece 52 according to the comparison standard and the sensing result of the each sensing component 68 sensing the light emitted from the each light emitting component 66 and reflected from the workpiece 52. If the control unit 70 determines to control the driving component 64 to drive the operating component 62 to press the attachment to the workpiece 52, go to step 106. If the control unit 70 determines not to control the driving component 64 to drive the operating component 62 to press the attachment to the workpiece 52, go to step 100.

Step 106: The control unit 70 controls the driving component 64 to drive the operating component 62 to press the attachment to the workpiece 52.

Step 108: The end.

Detail description of previous steps is described herein. First, an operator makes sure that each light emitting component 66 is located on the corresponding guiding slot 601 and in a desired position. If not, the operator adjusts the light emitting component 66 to the desired position. Then, the workpiece 52 is disposed in the locating structure 561 of the locating component 56, and the activating unit 76 on the test device 50 is activated. After that, the activating unit 76 sends the activating signal to the control unit 70, so that the control unit 70 controls each light emitting component 66 to emit the light to the workpiece 52 located on the locating component 56. In one of the previous embodiments, the control unit 70 controls the four light emitting components 66 to emit the light to the four corners or the four sides of the workpiece 52. Next, the four sensing components 68 sense the light reflected from the four corners or the four sides of the workpiece 52 respectively so as to send the sensing result to the control unit 70. Finally, the control unit 70 determines whether to control the driving component 64 to drive the operating component 62 to press the attachment onto the workpiece 52 according to the comparison standard and the sensing result of the four sensing components 68 sensing the light emitted from the four light emitting components 66 and reflected from the four corners or the four sides of the workpiece 52.

A mechanism for determining whether to control the driving component 64 to drive the operating component 62 to press the attachment onto the workpiece 52 by the control unit 70 can be implemented by different methods. For example, the control unit 70 can calculate the four distance characteristic values D1-D4 according to the sensing result of the four sensing components 68 sensing the light emitted from the four light emitting components 66 and reflected from the four corners or the four sides of the workpiece 52, and the control unit 70 determines whether to control the driving component 64 to drive the operating component 62 to press the attachment onto the workpiece 52 according to the comparison standard and the four distance characteristic values D1-D4. The control unit 70 can calculate the average value DA of the four distance characteristic values D1-D4 first, and then calculate the differences DE1˜DE4 between the four distance characteristic values D1˜D4 and the average value DA. Finally, the control unit 70 compares the differences DE1˜DE4 with the predetermined tolerance E1 respectively. If the differences DE1-DE4 are all less than the predetermined tolerance E1, it indicates that the differences of distances between the four corners of the workpiece 52 and the four sensing components 68 are small, so that the workpiece 52 is disposed inside the locating structure 561 horizontally. Therefore, the control unit 70 controls the driving component 64 to drive the operating component 62 to press the attachment onto the workpiece 52, and the operating component 62 does not damage the workpiece 52. On the contrary, if one or more than one of differences are greater than the predetermined tolerance E1, it means the workpiece 52 is not disposed in the locating structure 561 horizontally, and the control unit 70 does not control the driving component 64 to move, so as to prevent the operating component 62 from damaging the workpiece 52.

Furthermore, another method for determining whether to control the driving component 64 to drive the operating component 62 to press the attachment onto the workpiece 52 by the control unit 70 is described as follows. The storage unit 74 can store the four predetermined distance characteristic values PD1-PD4 in advance. Similarly, the control unit 70 calculates the four distance characteristic values D1-D4 according to the sensing result of the four sensing components 68 sensing the light emitted from the four light emitting components 66 and reflected from the four corners or the four sides of the workpiece 52. Then, the control unit 70 compares the differences DE1-DE4 with the four predetermined distance characteristic values PD1-PD4 respectively, and the control unit 70 determines whether to control the driving component 64 to drive the operating component 62 to press the attachment onto the workpiece 52 according to the comparison standard and the comparison result. The control unit 70 calculates the differences DE5-DE8 between the four distance characteristic values D1-D4 and the four predetermined distance characteristic values PD1-PD4, and the control unit 70 compares the differences DE5-DE8 with the predetermined tolerance E2. If the differences DE5-DE8 are all less than the predetermined tolerance E2, it indicates that the distances between the four corners of the workpiece 52 and the four sensing components 68 are all within the predetermined range, so that the workpiece 52 is disposed inside the locating structure 561 of the locating component 56 horizontally. Therefore, the control unit 70 can control the driving component 64 to drive the operating component 62 to press the attachment onto the workpiece 52, and the operating component 62 does not damage the workpiece 52. On the contrary, if one or more than one of differences are greater the predetermined tolerance E2, it means that the workpiece 52 is not disposed in the locating structure 561 horizontally, and the control unit 70 does not control the driving component 64 to press the attachment onto the workpiece 52, so as to prevent the operating component 62 from damaging the workpiece 52.

In contrast to the prior art, the test device includes the control unit to control the plurality of light emitting components to emit the light to the workpiece, and the sensing result of the plurality of sensing components sensing the light emitted from the plurality of light emitting component and reflected from the workpiece is sent to the control unit. Finally, the control unit determines whether to control the driving component to drive the operating component to press the attachment onto the workpiece according to the comparison standard and the sensing result. That is, the test device can test whether the workpiece is disposed in the locating structure horizontally, so as to prevent the operating component from damaging the workpiece in the assembly procedure. Therefore, it solves the conventional problems that the workpiece is not correctly positioned on the fixture, resulting in damaging the workpiece in the procedure of assembly, wasting human power and increasing cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A test device for testing whether a workpiece is positioned correctly, the test device comprising:
a base;
a locating component installed on the base, a locating structure being formed on the locating component and for accommodating and locating the workpiece;
a platform disposed on the base and facing the base;
at least one linking component linking the base and the platform, so as to form a space between the base and the platform;
an operating component disposed on a side of the platform facing the locating component;
a driving component installed on the platform and for driving the operating component to move to the locating component or move away from the locating component selectively;
at least one light emitting component disposed on the platform, the at least one light emitting component being for emitting light to the workpiece located on the locating component;
at least one sensing component for sensing the light emitted from the at least one light emitting component and reflected from the workpiece; and
a control unit electrically connected to the driving component, the at least one light emitting component, the at least one sensing component and the driving component, the control unit being for determining whether to control the driving component to drive the operating component to move to the workpiece according to a comparison standard and a sensing result of the at least one sensing component sensing the light emitted from the at least one light emitting component and reflected from the workpiece.

2. The test device of claim 1, wherein at least one guiding structure is formed on the platform, and the at least one light emitting component is disposed on the corresponding at least one guiding structure for moving along the corresponding at least one guiding structure, so as to adjust a position of the at least one light emitting component.

3. The test device of claim 1, wherein the test device comprises a predetermined number of the light emitting components and a predetermined number of the sensing components, the control unit is further for controlling the predetermined number of the light emitting components to emit the light to the workpiece, and the control unit determines whether to control the driving component to drive the operating component to move to the workpiece according to the comparison standard and the sensing result of the predetermined number of the sensing components sensing the light emitted from the predetermined number of the light emitting components and reflected from the workpiece.

4. The test device of claim 3, further comprising a storage unit for storing at least one predetermined distance characteristic value, and the control unit being further for calculating a predetermined number of distance characteristic values after the predetermined number of the sensing components sense the light emitted from the predetermined number of the light emitting components and reflected from the workpiece, and the control unit determining whether to control the driving component to drive the operating component to move to the workpiece according to the comparison standard of comparing the predetermined number of distance characteristic values with the at least one predetermined distance characteristic value.

5. The test device of claim 4, wherein the control unit is for controlling the driving component to drive the operating component to move to the workpiece as the control unit determines that every difference between the predetermined number of distance characteristic values and the at least one predetermined distance characteristic value is less than a predetermined tolerance.

6. The test device of claim 3, wherein the control unit is further for calculating a predetermined number of distance characteristic values after the predetermined number of the sensing components sense the light emitted from the predetermined number of the light emitting components and reflected from the workpiece, and the control unit determines whether to control the driving component to drive the operating component to move to the workpiece according to the predetermined number of distance characteristic values.

7. The test device of claim 6, wherein the control unit is for controlling the driving component to drive the operating component to move to the workpiece as the control unit determines that every difference between the predetermined number of distance characteristic values and an average value of the predetermined number of distance characteristic values is less than a predetermined tolerance.

8. The test device of claim 6, wherein the control unit is for controlling the driving component to drive the operating component to move to the workpiece as the control unit determines that a difference between a maximum distance characteristic value and a minimum distance characteristic value of the predetermined number of distance characteristic values is less than a predetermined tolerance.

9. The test device of claim 1, wherein the control unit is further for controlling the at least one light emitting component to emit the light to a corner or a side of the workpiece and determining whether to control the driving component to drive the operating component to move to the workpiece according to the comparison standard and the sensing result of the at least one sensing component sensing the light emitted from the at least one light emitting component and reflected from the corner or the side of workpiece.

10. The test device of claim 1, wherein the at least one light emitting component is a far infrared lamp or a laser emitter.

11. The test device of claim 1, wherein the driving component is a cylinder.

12. The test device of claim 1, further comprising an activating unit electrically connected to the control unit and being for sending an activating signal to the control unit, so that the control unit controls the at least one light emitting component to emit the light.

13. The test device of claim 1, wherein at least one guiding structure is formed on the platform, an adjustable fixing component corresponding to the at least one guiding structure is movably disposed on the at least one guiding structure of the platform, and the at least one light emitting component is fixed on the adjustable fixing component, so that the at least one light emitting component moves with the adjustable fixing component when the adjustable fixing component moves relative to the at least one guiding structure.

14. A method for testing whether a workpiece is positioned correctly, the method comprising:
at least one light emitting component emitting light to a workpiece located on a locating component;
at least one sensing component sensing the light emitted from the at least one light emitting component and reflected from the workpiece; and
a control unit determining whether to control the driving component to drive the operating component to move to the workpiece according to a comparison standard and a sensing result of the at least one sensing component sensing the light emitted from the at least one light emitting component and reflected from the workpiece.

15. The method of claim 14, wherein the at least one light emitting component emitting the light to the workpiece located on the locating component comprises a predetermined number of the light emitting components emitting the light to the workpiece, the at least one sensing component sensing the light emitted from the at least one light emitting component and reflected from the workpiece comprises a predetermined number of sensing components sensing the light emitted from the predetermined number of light emitting components and reflected from the workpiece, the control unit determining whether to control the driving component to drive the operating component to move to the workpiece according to the comparison standard and the sensing result of the at least one sensing component sensing the light emitted from the at least one light emitting component and reflected from the workpiece comprises the control unit determining whether to control the driving component to drive the operating component to move to the workpiece according to the comparison standard and the sensing result of the predetermined number of sensing components sensing the light emitted from the predetermined number of light emitting components and reflected from the workpiece.

16. The method of claim 15, further comprising storing at least one predetermined distance characteristic value to a storage unit, the control unit calculating predetermined number of distance characteristic values after the predetermined number of the sensing components sense the light emitted from the predetermined number of the light emitting components and reflected from the workpiece, and the control unit determining whether to control the driving component to drive the operating component to move to the workpiece according to a comparison result generated by comparing the predetermined number of distance characteristic values with the at least one predetermined distance characteristic value.

17. The method of claim 16, wherein the control unit determining whether to control the driving component to drive the operating component to move to the workpiece according to the comparison result generated by comparing the predetermined number of distance characteristic values with the at least one predetermined distance characteristic value comprises the control unit controlling the driving component to drive the operating component to move to the workpiece as the control unit determines that every difference between the predetermined number of distance characteristic values and the at least one predetermined distance characteristic value is less than a predetermined tolerance.

18. The method of claim 15, wherein the control unit determining whether to control the driving component to drive the operating component to move to the workpiece according to the comparison standard and the sensing result of the predetermined number of sensing components sensing the light emitted from the predetermined number of light emitting components and reflected from the workpiece comprises the control unit calculating predetermined number of distance characteristic values after the predetermined number of the sensing components sense the light emitted from the predetermined number of the light emitting components and reflected from the workpiece, and the control unit determining whether to control the driving component to drive the operating component to move to the workpiece according to the predetermined number of distance characteristic values.

19. The method of claim 18, wherein the control unit determining whether to control the driving component to drive the operating component to move to the workpiece according to the predetermined number of distance characteristic values comprises the control unit controlling the driving component to drive the operating component to move to the workpiece as the control unit determines that every difference between the predetermined number of distance characteristic values and an average value of the predetermined number of distance characteristic values is less than a predetermined tolerance.

20. The method of claim 18, wherein the control unit determining whether to control the driving component to drive the operating component to move to the workpiece according to the predetermined number of distance characteristic values comprises the control unit controls the driving component to drive the operating component to move to the workpiece as the control unit determines that a difference between a maximum distance characteristic value and a minimum distance characteristic value of the predetermined number of distance characteristic values is less than a predetermined tolerance.

21. The method of claim 14, wherein the at least one light emitting component emitting the light to the workpiece located on the locating component comprises the at least one light emitting component emitting the light to a corner or a side of the workpiece, the control unit determining whether to control the driving component to drive the operating component to move to the workpiece according to the comparison standard and the sensing result of the at least one sensing component sensing the light emitted from the at least one light emitting component and reflected from the workpiece comprises the control unit determining whether to control the driving component to drive the operating component to move to the workpiece according to the comparison standard and the sensing result of the at least one sensing component sensing the light emitted from the at least one light emitting component and reflected from the corner or the side of the workpiece.
